(19) United States
(12) Patent Application Publication
(10) Pub. No.: US 2007/0290974 A1
(43) Pub. Date: Dec. 20, 2007

(54) Liquid crystal display panel and driving method thereof

(75) Inventors: Shu-I Huang, Taipei City (TW); Chung-Lung Li, Taipei City (TW); Wei-Chieh Sun, Yonghe City (TW)

Correspondence Address: RABIN & Berdo, PC, 1101 14TH STREET, NW, SUITE 500, WASHINGTON, DC, 20005, US

(73) Assignee: AU OPTRONICS CORP., Hsinchu (TW)

(21) Appl. No.: 11/580,052

(22) Filed: Oct. 13, 2006

(30) Foreign Application Priority Data
Jun. 14, 2006 (TW) 95121206

(51) Int. Cl. G09G 3/36

(52) U.S. Cl. 345/92

(57) ABSTRACT

A liquid crystal display panel comprising a first substrate, a second substrate and a liquid crystal layer is provided. The first substrate comprises a first base, a first pattern and a second pattern. The first pattern and the second pattern are disposed on the first base. The second substrate comprises a second base, a first data line, a first scan line, a second scan line, a first pixel, and a second pixel. The first pattern and the second pattern are symmetric with respect to the first data line. The first pixel comprises a first thin-film-transistor coupled to the first scan line and the first data line. The second pixel comprises a second thin-film-transistor coupled to the second scan line and the first data line. The liquid crystal layer is disposed between the first substrate and the second substrate.

This application claims the benefit of Taiwan application Serial No. 95121206, filed Jun. 14, 2006, the subject matter of which is incorporated herein by reference.

### BACKGROUND OF THE INVENTION

1. Field of the Invention

The invention relates in general to a liquid crystal display panel and a driving method thereof, and more particularly to a liquid crystal display panel with high aperture rate and a driving method thereof.

2. Description of the Related Art

Referring to FIG. 1, a partial layout of part of a conventional liquid crystal display panel is shown. The liquid crystal display panel 10 comprises a thin-film-transistor substrate (not illustrated) and a color filter substrate (not illustrated). The color filter substrate is correspondingly disposed over the thin-film-transistor substrate. There is a liquid crystal layer (not illustrated) between the two substrates. The thin-film-transistor substrate comprises a first scan line G1, a second scan line G2, a first data line D1, a second data line D2 and a third data line D3. The scan lines G1 and G2 are disposed in parallel. The data lines D1, D2 and D3 are disposed in parallel and respectively perpendicular to the scan lines G1 and G2 to define a first pixel P1 and a second pixel P2. The first pixel P1 comprises a first thin-film-transistor T1 and a first pixel electrode 18. The first thin-film-transistor T1 is electrically connected to the second scan line G2, the second data line D2 and the first pixel electrode 18. The second pixel P2 comprises a second thin-film-transistor T2 and a second pixel electrode 19. The second thin-film-transistor T2 is electrically connected to the second scan line G2, the third data line D3 and the second pixel electrode 19. The color filter substrate comprises a first bump 15 and a second bump 16. The first bump 15 and the second bump 16 are used for adjusting the liquid crystal molecules of liquid crystal layer into multiple display regions. For example, the first bump 15 divides the first pixel P1 into a first region A1, a second region A2 and a third region A3. The first region A1 and the third region A3 are disposed to the right of the first bump 15 to control the transmittance when viewed from the right. The second region A2 is disposed to the left of the first bump 15 to control the transmittance when viewed from the left. Preferably, the sum of the area of the first region A1 and the third region A3 are equal to the area of the second region A2, such that the transmittance when viewed from the right is the same with the transmittance when viewed from the left.

During the manufacturing process of the liquid crystal display panel, the top substrate and the bottom substrate are easily malpositioned during the step of coupling the two substrates. When the color filter substrate is shifted to the right, the area of the second region A2 is increased, such that the area of the second region A2 is larger than the sum of the area of the first region A1 and the third region A3. Besides, in the neighboring second pixel P2, the area of the fifth region A5 is larger than the sum of the area of the fourth region A4 and the sixth region A6. Thus, in terms of the user, the transmittance when viewed from the left is apparently higher than the transmittance when viewed from the right, resulting in asymmetry between the rate of brightness change corresponding to the change in grey level when viewed from the right and the rate of brightness change corresponding to the change in grey level when viewed from the left. Therefore, it has become an imminent issue to resolve the asymmetry between the rate of brightness change when viewed from the left of the liquid crystal display panel and the rate of brightness change when viewed from the right of the liquid crystal display panel due to the malposition between the top substrate and the bottom substrate.

### SUMMARY OF THE INVENTION

It is therefore an object of the invention to provide a liquid crystal display panel and a driving method thereof. The symmetry between the rate of brightness change corresponding to the change in grey level when viewed from the right and the rate of brightness change corresponding to the change in grey level when viewed from the left as well as the aperture rate of pixel are improved, such that the image display quality of the liquid crystal display panel is improved.

The invention achieves the above-identified object by providing a liquid crystal display panel comprising a first substrate, a second substrate and a liquid crystal layer. The first substrate comprises a first base, a first pattern and a second pattern. The first pattern and the second pattern are disposed on the first base. The second substrate comprises a second base, a first data line, a first scan line, a second scan line, a first pixel, and a second pixel. The first data line is disposed on the second base. The first pattern and the second pattern are symmetric with respect to the first data line. The first scan line and the second scan line are both disposed on the second base and perpendicular to the first data line. The first pixel comprises a first thin-film-transistor coupled to the first scan line and the first data line. The second pixel comprises a second thin-film-transistor coupled to the second scan line and the first data line. The liquid crystal layer is interposed between the first substrate and the second substrate.

The invention further achieves the above-identified object by providing a driving method applicable to the abovementioned liquid crystal display panel. The driving method is disclosed below. Firstly, during a first timing period, a first thin-film-transistor and a second thin-film-transistor are sequentially and respectively turned on via a first scan line and a second scan line. Then, a pixel voltage is provided to the first thin-film-transistor and the second thin-film-transistor via a first data line.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a partial layout of part of a conventional liquid crystal display panel;

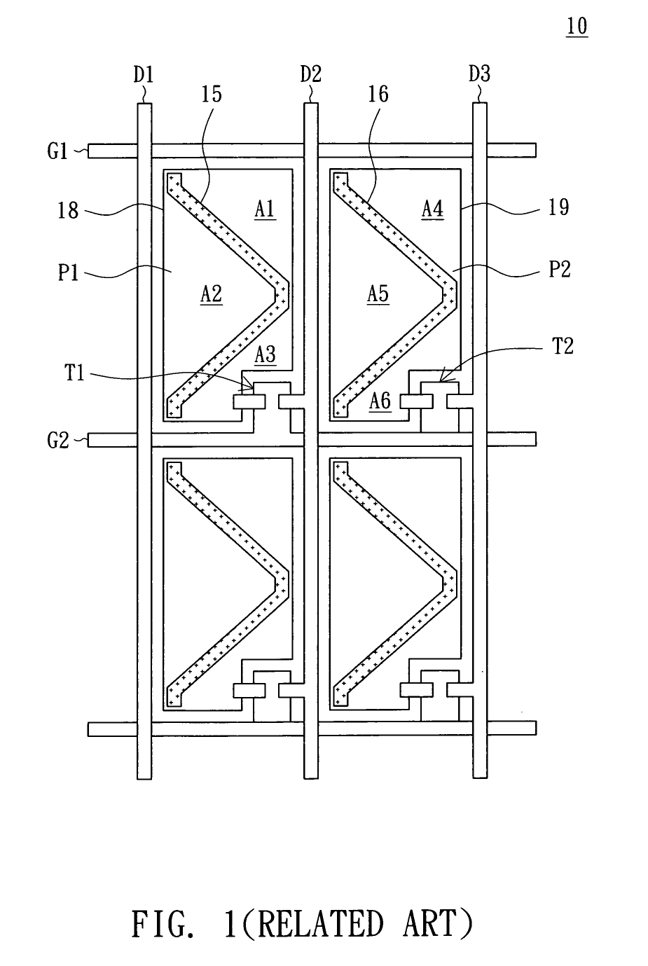

FIG. 2A is a partial layout of a liquid crystal display panel using a bump as a mirror reflection;

FIG. 2B is a partial cross-sectional view of a liquid crystal display panel viewed along cross-sectional line 2B-2B′ of FIG. 2A;

FIG. 2C is a partial cross-sectional view of a liquid crystal display panel of FIG. 2A after a color filter substrate is shifted to the right;

FIG. 3 is a partial layout of a liquid crystal display panel using a thin-film-transistor as a mirror reflection;

FIG. 4A is a partial layout of a liquid crystal display panel according to an embodiment of the invention;

FIG. 4B is another example of a partial layout of a liquid crystal display panel according to an embodiment of the invention;

FIG. 5 is a second example of a partial layout of a liquid crystal display panel according to an embodiment of the invention;

FIG. 6 is a third example of a partial layout of a liquid crystal display panel according to an embodiment of the invention;

FIG. 7 is a fourth example of a partial layout of a liquid crystal display panel according to an embodiment of the invention; and

FIG. 8 is a fifth example of a partial layout of a liquid crystal display panel according to an embodiment of the invention.

### DETAILED DESCRIPTION OF THE INVENTION

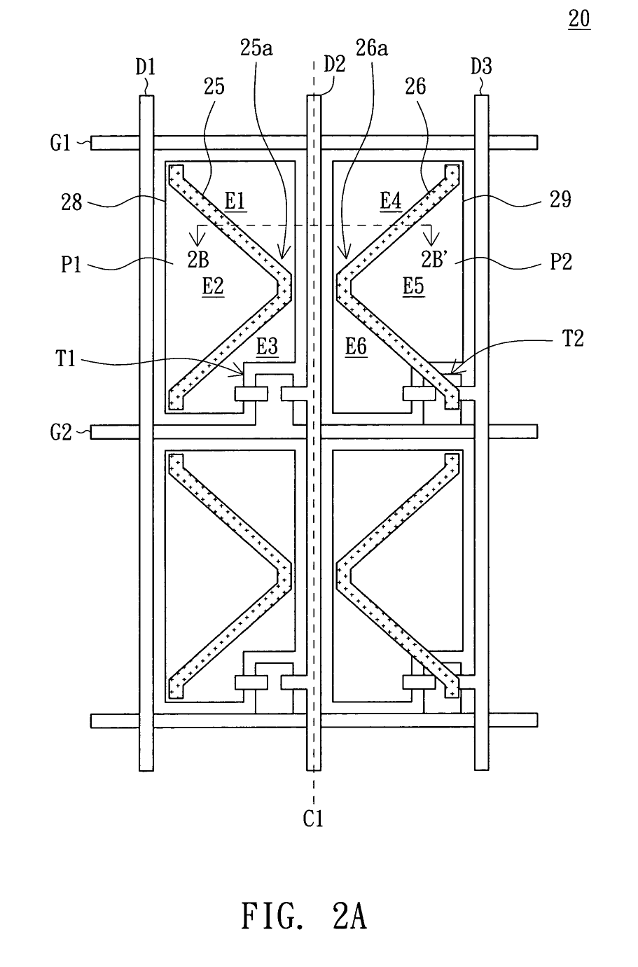

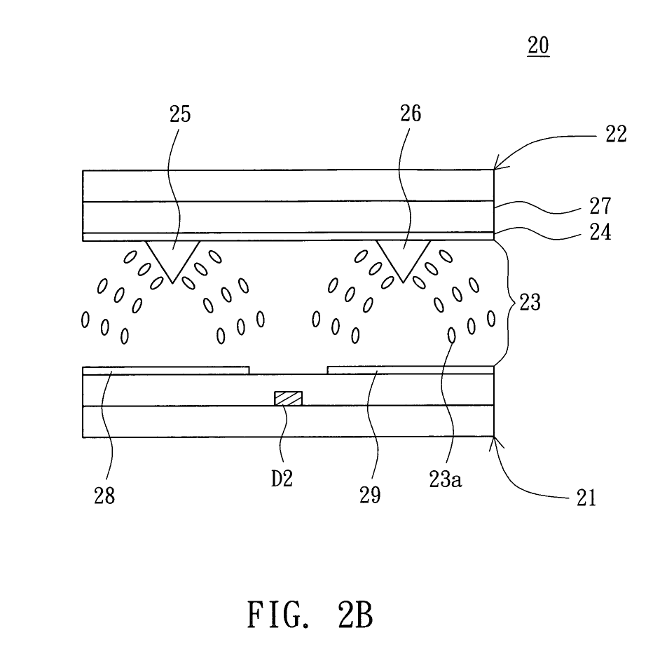

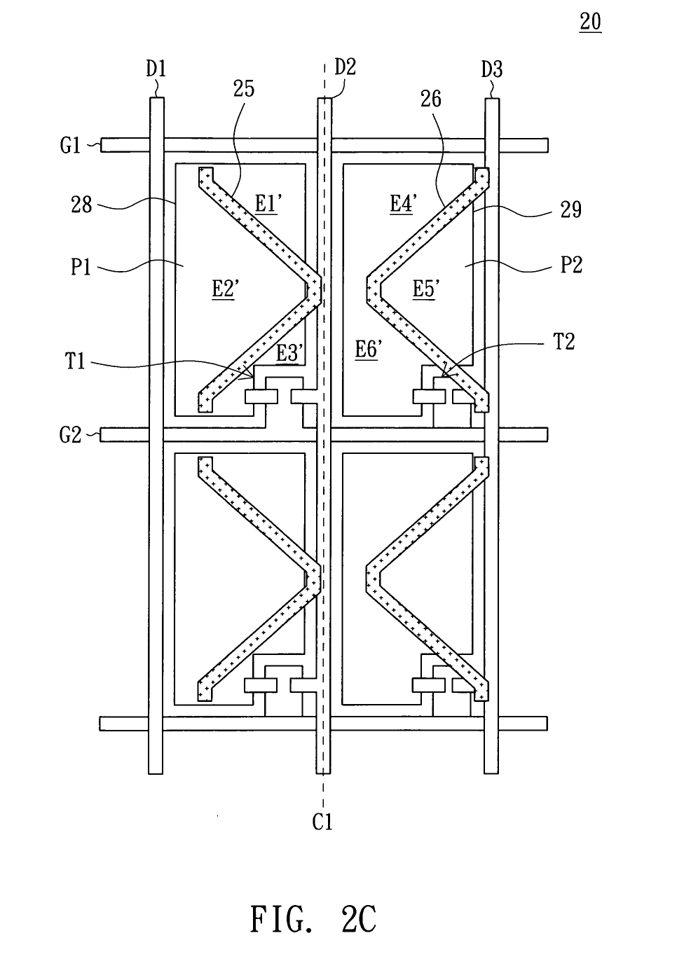

In order to resolve the problem of asymmetry, between the transmittance when viewed from the left and/or between the transmittance when viewed from the right, which occurs due to the malposition of two substrates, the bump is designed as a mirror reflection in the invention. Referring to FIG. 2A, a partial layout of a liquid crystal display panel using bumps as a mirror reflection is shown. Referring to FIG. 2B, a partial cross-sectional view of a liquid crystal display panel viewed along cross-sectional line 2B-2B′ of FIG. 2A is shown. The liquid crystal display panel 20 comprises a thin-film-transistor substrate 21, a color filter substrate 22 and a liquid crystal layer 23. The thin-film-transistor substrate 21 and the color filter substrate 22 are disposed in parallel and opposite to each other. The liquid crystal layer 23 is interposed between the thin-film-transistor substrate 21 and the color filter substrate 22, and comprises a number of liquid crystal molecules 23a. Besides, the thin-film-transistor substrate 21 comprises a first scan line G1, a second scan line G2, a first data line D1, a second data line D2 and a third data line D3. The scan lines G1 and G2 are disposed in parallel. The data lines D1, D2 and D3 are disposed in parallel and respectively perpendicular to the scan lines G1 and G2 to define areas of a first pixel P1 and a second pixel P2. The first pixel P1 comprises a first thin-film-transistor T1 and a first pixel electrode 28. The first thin-film-transistor T1 is electrically connected to the second scan line G2, the second data line D2 and the first pixel electrode 28. The second pixel P2 comprises a second thin-film-transistor T2 and a second pixel electrode 29. The second thin-film-transistor T2 is electrically connected to the second scan line G2, the third data line D3 and the second pixel electrode 29. The color filter substrate 22 comprises a common electrode 24, a first bump 25, a second bump 26 and a color filter 27. The first bump 25 and the second bump 26 are disposed on the common electrode 24 to be opposite to the first pixel electrode 28 and the second pixel electrode 29, respectively.

In the liquid crystal display panel 20, the second bump 26 is a mirror reflection of the first bump 25 with respect to a first central line C1. That is, a top end 25a of the first bump 25 and a top end 26a of the second bump 26 are both towards the first central line C1. The central line C1 is, for example, the second data line D2 as depicted in FIG. 2A. The first bump 25 and the second bump 26 are used for adjusting the liquid crystal molecules of the liquid crystal layer into multiple display regions. For example, the first bump 25 divides the first pixel P1 into a first region E1, a second region E2 and a third region E3. Suppose that the color filter substrate 22 is shifted to the right during the manufacturing process of the liquid crystal display panel, that is, the first bump 25 and the second bump 26 are shifted to the right. Referring to FIG. 2C, a top view of a liquid crystal display panel of FIG. 2A after a color filter substrate is shifted to the right is shown. It can be seen from FIG. 2C that after the color filter substrate 22 is shifted to the right, the area of the second region E2′ is increased, such that the area of the second region E2′ is larger than the sum of the area of the first region E1′ and the third region E3′. Besides, in the neighboring second pixel P2, the area of the fifth region E5′ is reduced, such that the area of the fifth region E5′ is smaller than the sum of the area of the fourth region E4′ and the sixth region E6′. The second region E2′ is symmetric to the fifth region E5′, the first region E1′ is symmetric to the fourth region E4′, and the third region E3′ is symmetric to the sixth region E6′. In terms of the first pixel P1, the transmittance when viewed from the right is increased but the transmittance when viewed from the left is decreased. In terms of the neighboring second pixel P2, the transmittance when viewed from the right is decreased but the transmittance when viewed from the left is increased. Thus, in terms of the user, the transmittance when viewed from the left should theoretically be the same with the transmittance when viewed from the right.

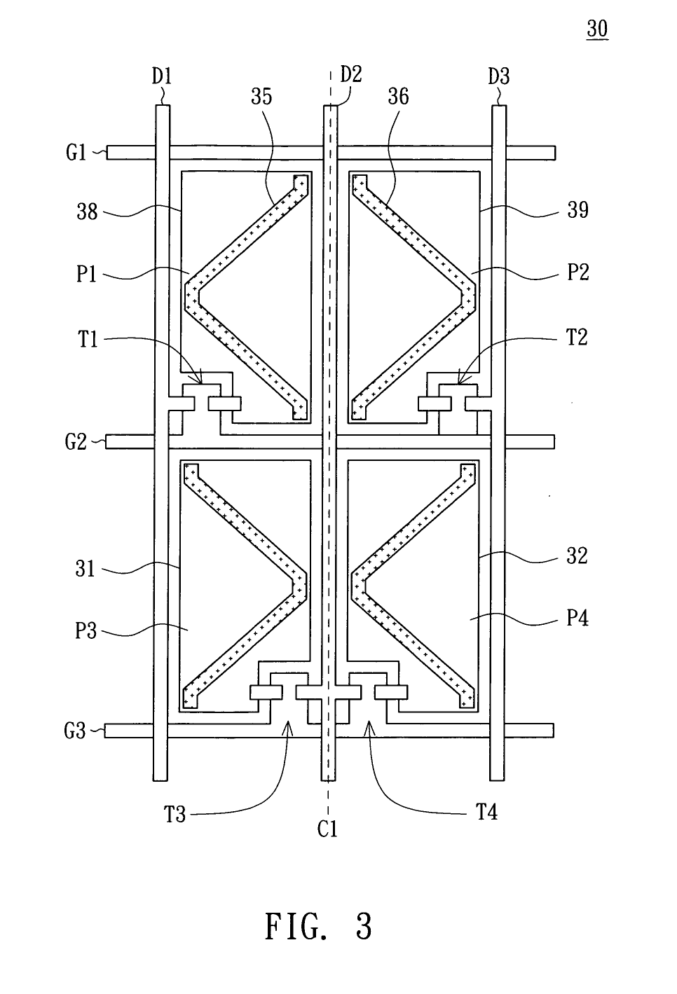

The invention further provides a liquid crystal display panel having a mirror reflection arrangement of the thin-film-transistors with respect to the data lines. Referring to FIG. 3, a partial layout of a liquid crystal display panel using a thin-film-transistor as a mirror reflection is shown. FIG. 3 differs with FIG. 2A in that, in the liquid crystal display panel 30, the second thin-film-transistor T2 is a mirror reflection of the first thin-film-transistor T1 with respect to the first central line C1. That is, the first thin-film-transistor T1 changes to be coupled to the second scan line G2, the first data line D1 and the first pixel electrode 38, but the second thin-film-transistor T2 maintains being coupled to the second scan line G2, the third data line D3 and the second pixel electrode 39. Thus, the first bump 35 does not shield the first thin-film-transistor T1, nor does the second bump 36 shield the second thin-film-transistor T2. Consequently, the two pixels P1 and P2 have the same transmittance.

As shown in FIG. 3, the liquid crystal display panel 30 further comprises a third scan line G3 parallel to the first scan line G1 and the second scan line G2 to define areas of a third pixel P3 and a fourth pixel P4 with the data lines D1˜D3. The third pixel P3 comprises a third thin-film-transistor T3 and a third pixel electrode 31. The fourth pixel P4 comprises a fourth thin-film-transistor T4 and a fourth pixel electrode 32. The fourth thin-film-transistor T4 is a mirror reflection of the third thin-film-transistor T3 with respect to the first central line C1. The third thin-film-transistor T3 is coupled to the third scan line G3, the second data line D2 and the third pixel electrode 31. The fourth thin-film-transistor T4 is coupled to the third scan line G3, the second data line D2 and the fourth pixel electrode 32.

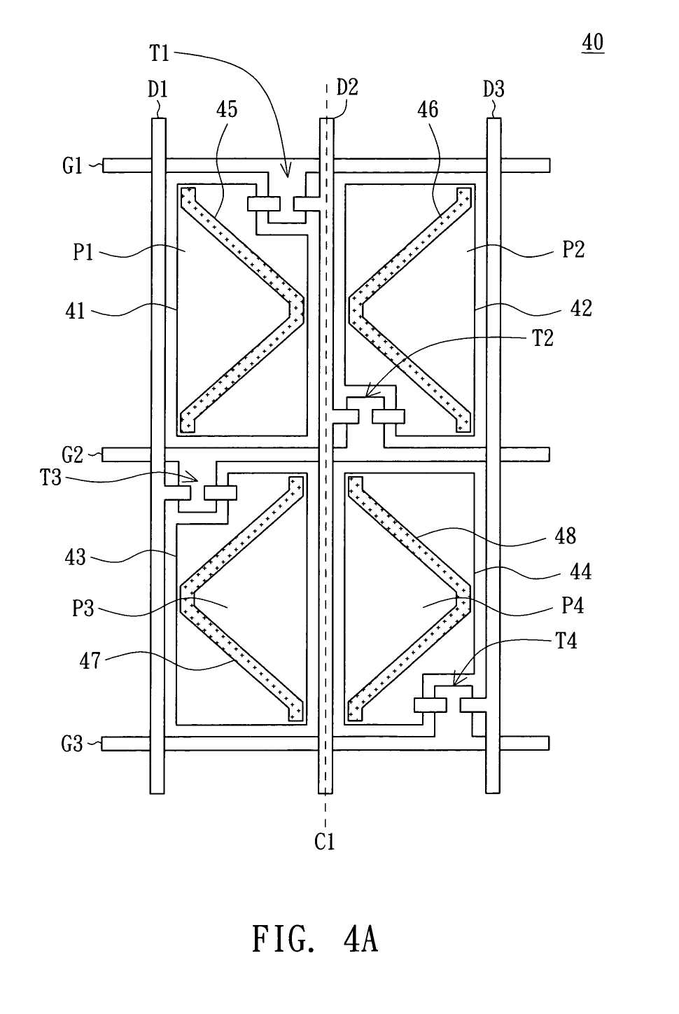

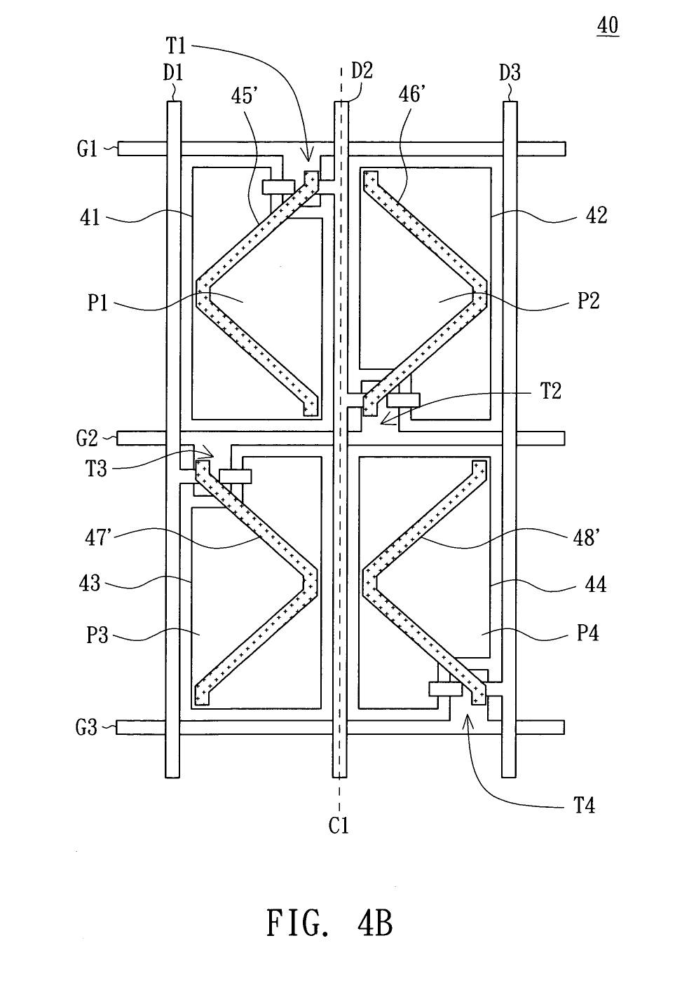

Referring to FIG. 4A, a partial layout of a liquid crystal display panel according to an embodiment of the invention is shown. The liquid crystal display panel 40 comprises a color filter substrate, a thin-film-transistor substrate and a liquid crystal layer. The disposition of the color filter substrate, the thin-film-transistor substrate and the liquid crystal layer is the same with FIG. 2B and is not repeated here. The color filter substrate comprises a first base (not illustrated), a first bump 45 and a second bump 46. The first bump 45 and the second bump 46 are both disposed on the first base to be symmetric with respect to the first central line C1. The second bump 46 is a mirror reflection of the first bump 45 with respect to the first central line C1. In other words, the first bump 45 is also a mirror reflection of the second bump 46 with respect to the first central line C1. The thin-film-transistor substrate comprises a second base (not illustrated), a first data line D1, a second data line D2, a third data line D3, a first scan line G1, a second scan line G2, a first pixel P1 and a second pixel P2. The first data line D1, the second data line D2 and the third data line D3 are disposed on the second base in parallel. The first central line C1 is positioned above the second data line D2. The first scan line G1 and the second scan line G2 are disposed on the second base in parallel and respectively perpendicular to the first data line. The first pixel P1 comprises a first thin-film-transistor T1 and a first pixel electrode 41. The first thin-film-transistor T1 is coupled to the first scan line G1, the second data line D2 and the first pixel electrode 41. The second pixel P2 comprises a second thin-film-transistor T2 and a second pixel electrode 42. The second thin-film-transistor T2 is coupled to the second scan line G2, the second data line D2 and the second pixel electrode 42. Preferably, both the first bump 45 and the second bump 46 are a V-shaped bump whose top end is towards the first central line C1.

As shown in FIG. 4A, the first bump 45 does not partially overlap with the first thin-film-transistor T1, nor does the second bump 46 partially overlap with the second thin-film-transistor T2. Therefore, the transmittance of the first pixel P1 is the same with the transmittance of the second pixel P2. In the first embodiment of the invention, the first thin-film-transistor T1 and the second thin-film-transistor T2 are coupled to the same data line D2. However, since the first thin-film-transistor T1 and the second thin-film-transistor T2 are respectively coupled to the scan line G1 and the scan line G2, the first thin-film-transistor T1 and the second thin-film-transistor T2 may not be turned on at the same time. The second data line D2 may provide a pixel voltage to the two neighboring pixels P1 and P2 simultaneously or non-simultaneously.

Besides, the thin-film-transistor substrate further comprises a third scan line G3, a third pixel P3 and a fourth pixel P4. The third scan line G3 is disposed on the second base. The second scan line G2 is disposed between the first scan line G1 and the third scan line G3. The third pixel P3 comprises a third thin-film-transistor T3 and a third pixel electrode 43. The fourth pixel P4 comprises a fourth thin-film-transistor T4 and a fourth pixel electrode 44. The third thin-film-transistor T3 is coupled to the second scan line G2, the first data line D1 and the third pixel electrode 43. The fourth thin-film-transistor T4 is coupled to the third scan line G3, the third data line D3 and the fourth pixel electrode 44. The color filter substrate further comprises a third bump 47 and a fourth bump 48 both are disposed on the first base to be symmetric with respect to the first central line C1. The fourth bump 48 is a mirror reflection of the third bump 47 with respect to the first central line C1. Preferably, both the third bump 47 and the fourth bump 48 are a V-shaped bump whose opening faces the first central line C1. That is, the direction of the opening of the third bump 47 is opposite to the direction of the opening of the first bump 45. The third bump 47 does not partially overlap with the third thin-film-transistor T3, nor does the fourth bump 48 partially overlap with the fourth thin-film-transistor T4.

The pixel driving method of the liquid crystal display panel 40 is disclosed below. Firstly, during a first timing period, the first thin-film-transistor T1 is turned on via the first scan line G1, and a corresponding pixel voltage is provided to the first pixel P1 via the second data line D2. Next, during a second timing period, the third thin-film-transistor T3 and the second thin-film-transistor T2 are sequentially turned on via the second scan line G2, a corresponding pixel voltage is provided to the third pixel P3 via the first data line D1, and a corresponding pixel voltage is provided to the second pixel P2 via the second data line D2. Lastly, during a third timing period, the fourth thin-film-transistor T4 is turned on via the third scan line G3, and a corresponding pixel voltage is provided to the fourth pixel P4 via the third data line D3. The pixel voltage illustrated above may be provided simultaneously or non-simultaneously.

Referring to FIG. 4B, another example of a partial layout of a liquid crystal display panel according to an embodiment of the invention is shown. FIG. 4B differs with FIG. 4A in that the opening of the V-shaped first bump 45′ and the opening of the V-shaped second bump 46′ face the first central line C1, such that part of the first bump 45′ partially overlaps with the first thin-film-transistor T1, and part of the second bump 46′ partially overlaps with the second thin-film-transistor T2. Thus, the transmittance of the first pixel P1 is still the same with the transmittance of the second pixel P2. Besides, the top end of the V-shaped third bump 47′ and the top end of the V-shaped fourth bump 48′ are both towards the first central line C1, such that part of the third bump 47′ partially overlaps with the third thin-film-transistor T3, and part of the fourth bump 48′ partially overlaps with the fourth thin-film-transistor T4. Thus, the transmittance of the third pixel P3 is still the same with the transmittance of the fourth pixel P4.

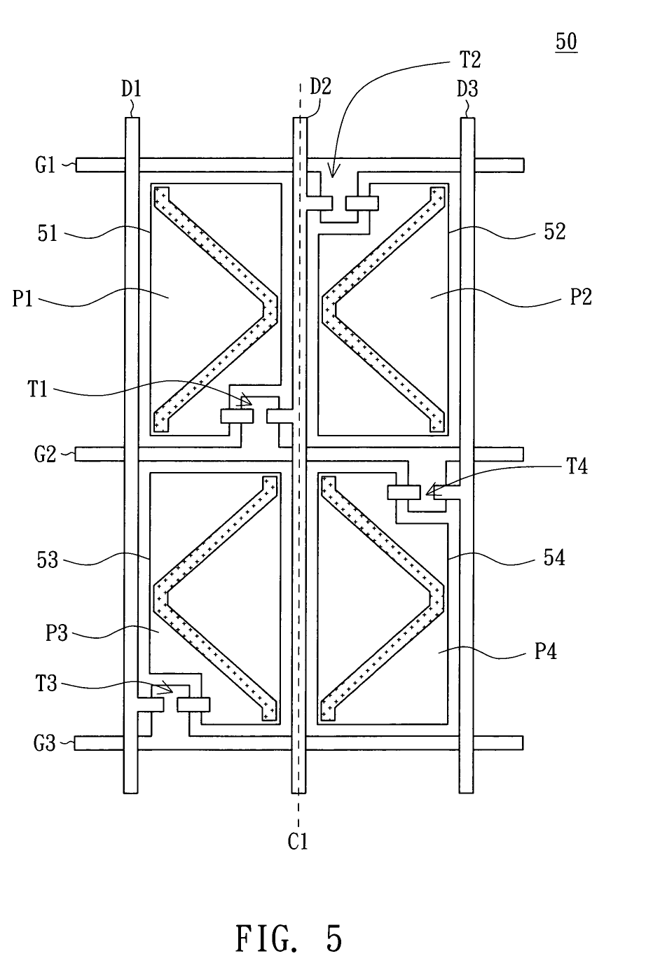

Referring to FIG. 5, a second example of a partial layout of a liquid crystal display panel according to an embodiment of the invention is shown. FIG. 5 differs with FIG. 4A and FIG. 4B in that, in the liquid crystal display panel 50, the first thin-film-transistor T1 is coupled to the second scan line G2, the second data line D2 and the first pixel electrode 51, the second thin-film-transistor T2 is coupled to the first scan line G1, the second data line D2 and the second pixel electrode 52, the third thin-film-transistor T3 is coupled to the third scan line G3, the first data line D1 and the third pixel electrode 53, and the fourth thin-film-transistor T4 is coupled to the second scan line G2, the third data line D3 and the fourth pixel electrode 54. The other elements are the same with the liquid crystal display panel 40 of FIG. 4A, and are not repeated here.

The pixel driving method of the liquid crystal display panel 50 is disclosed below. Firstly, during a first timing period, the second thin-film-transistor T2 is turned on via the first scan line G1, and a corresponding pixel voltage is provided to the second pixel P2 via the second data line D2. Next, during a second timing period, the first thin-film-transistor T1 and the fourth thin-film-transistor T4 are sequentially turned on via the second scan line G2, a corresponding pixel voltage is provided to the first pixel P1 via the second data line D2, and a corresponding pixel voltage is provided to the fourth pixel P4 via the third data line D3. Lastly, during a third timing period, the third thin-film-transistor T3 is turned on via the third scan line G3, and a corresponding pixel voltage is provided to the third pixel P3 via the first data line D1.

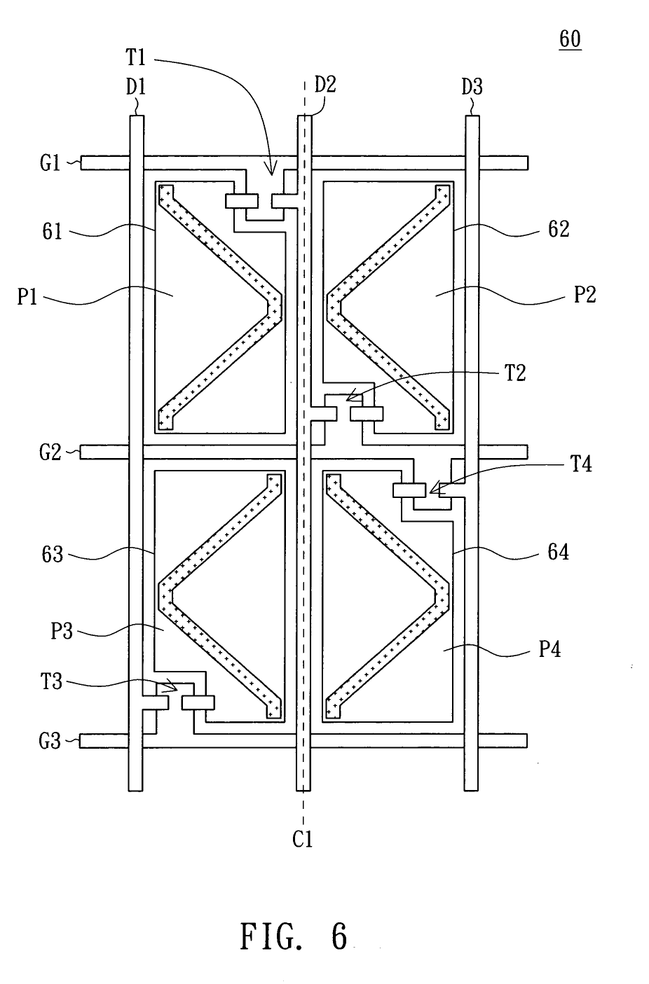

Referring to FIG. 6, a third example of a partial layout of a liquid crystal display panel according to an embodiment of the invention is shown. FIG. 6 differs with FIGS. 4A and 4B in that, in the liquid crystal display panel 60, the first thin-film-transistor T1 is coupled to the first scan line G1, the second data line D2 and the first pixel electrode 61, the second thin-film-transistor T2 is coupled to the second scan line G2, the second data line D2 and the second pixel electrode 62, the third thin-film-transistor T3 is coupled to the third scan line G3, the first data line D1 and the third pixel electrode 63, and the fourth thin-film-transistor T4 is coupled to the second scan line G2, the third data line D3 and the fourth pixel electrode 64. The other elements are the same with the liquid crystal display panel 40 of FIG. 4A, and are not repeated here.

The pixel driving method of the liquid crystal display panel 60 is disclosed below. Firstly, during a first timing period, the first thin-film-transistor T1 is turned on via the first scan line G1, and a corresponding pixel voltage is provided to the first pixel P1 via the second data line D2. Next, during a second timing period, the second thin-film-transistor T2 and the fourth thin-film-transistor T4 are sequentially turned on via the second scan line G2, a corresponding pixel voltage is provided to the second pixel P2 via the second data line D2, and a corresponding pixel voltage is provided to the fourth pixel P4 via the third data line D3. Lastly, during a third timing period, the third thin-film-transistor T3 is turned on via the third scan line G3, and a corresponding pixel voltage is provided to the third pixel P3 via the first data line D1. The pixel voltage illustrated above may be provided simultaneously or non-simultaneously.

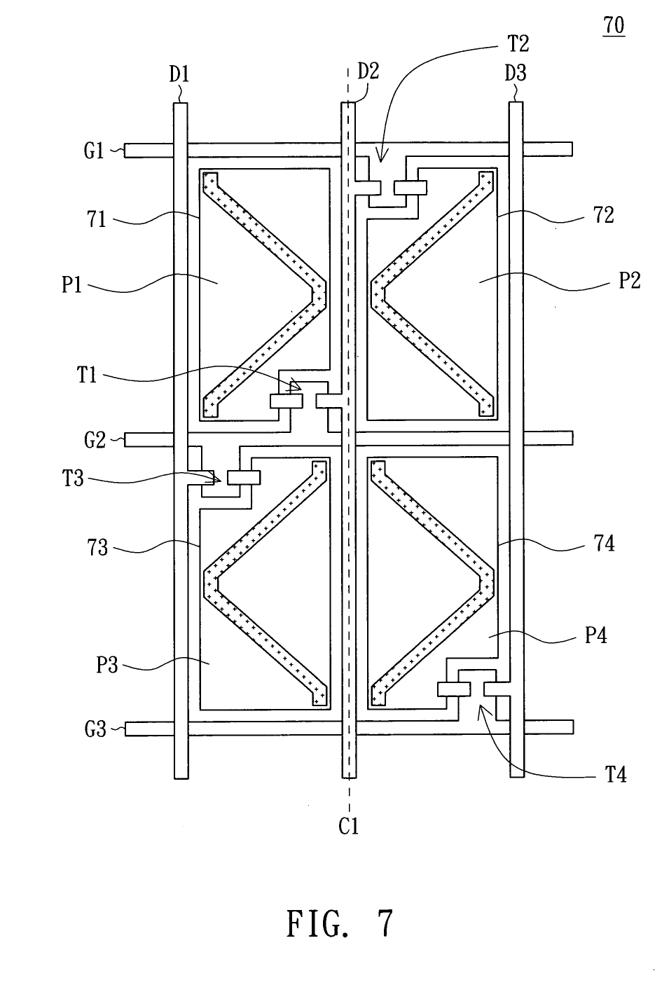

Referring to FIG. 7, a fourth example of a partial layout of a liquid crystal display panel according to an embodiment of the invention is shown. FIG. 7 differs with FIGS. 4A and 4B in that, in the liquid crystal display panel 70, the first thin-film-transistor T1 is coupled to the second scan line G2, the second data line D2 and the first pixel electrode 71, the second thin-film-transistor T2 is coupled to the first scan line G1, the second data line D2 and the second pixel electrode 72, the third thin-film-transistor T3 is coupled to the second scan line G2, the first data line D1 and the third pixel electrode 73, and the fourth thin-film-transistor T4 is coupled to the third scan line G3, the third data line D3 and the fourth pixel electrode 74. The other elements are the same with the liquid crystal display panel 40 of FIG. 4A, and are not repeated here.

The pixel driving method of the liquid crystal display panel 70 is disclosed below. Firstly, during a first timing period, the second thin-film-transistor T2 is turned on via the first scan line G1, and a corresponding pixel voltage is provided to the second pixel P2 via the second data line D2. Next, during a second timing period, the third thin-film-transistor T3 and the first thin-film-transistor T1 are sequentially turned on via the second scan line G2, a corresponding pixel voltage is provided to the third pixel P3 via the first data line D1, and a corresponding pixel voltage is provided to the first pixel P1 via the second data line D2. Lastly, during a third timing period, the fourth thin-film-transistor T4 is turned on via the third scan line G3, and a corresponding pixel voltage is provided to the fourth pixel P4 via the third data line D3.

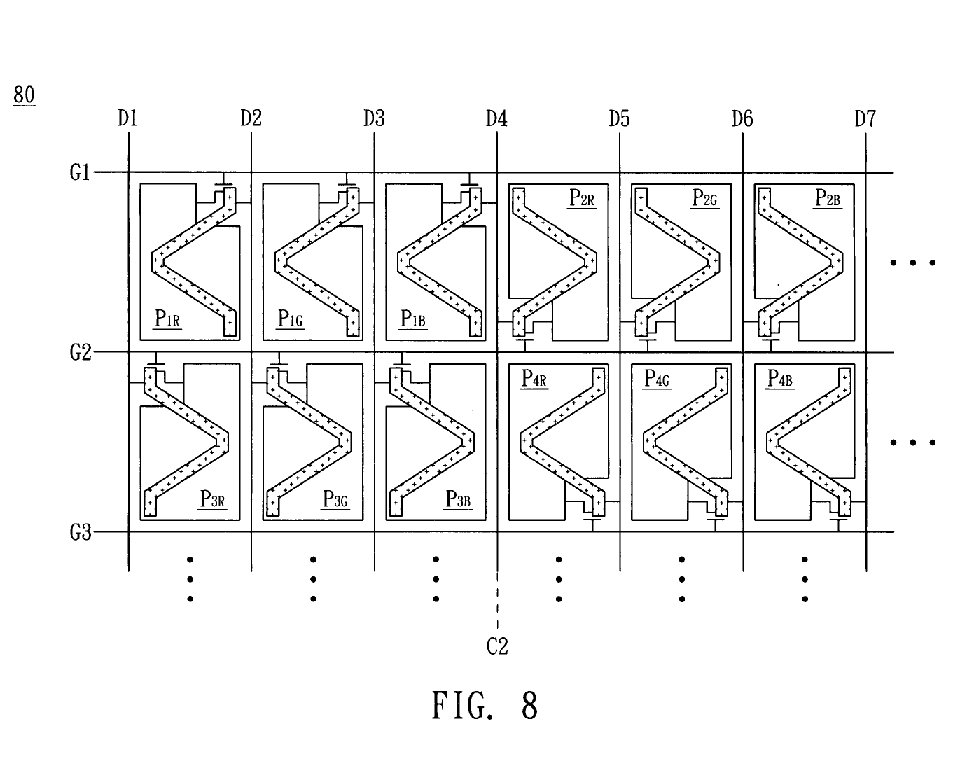

Despite the liquid crystal display panel and the driving method thereof are exemplified by the four pixels P1, P2, P3 and P4 in the above embodiments of the invention, however, the actual application is not limited thereto. Referring to FIG. 8, a fifth example of a partial layout of a liquid crystal display panel according to an embodiment of the invention is shown. In the liquid crystal display panel 80, the thin-film-transistors of the pixels P1R, P1G and P1B are all disposed at the top right corner of the corresponding pixel thereof, while the thin-film-transistors of the pixels P2R, P2G and P2B are all disposed at the bottom left corner of the corresponding pixel thereof. The pixels P1R and P2R are used for receiving the voltage of red pixels. The pixels P1G and P2G are used for receiving the voltage of green pixels. The pixels P1B and P2B are used for receiving the voltage of blue pixels. Besides, the V-shaped bump positioned above the pixels P1R, P1G and P1B, and the V-shaped bump positioned above the pixels P2R, P2G and P2B are disposed on the color filter substrate to be symmetric with respect to the second central line C2. The second central line C2 is positioned above the fourth data line D4. For example, if the openings of the V-shaped bumps positioned above the pixels P1R, P1G and P1B face the second central line C2, the V-shaped bumps positioned above the pixels P2R, P2G and P2B also face the second central line C2 for enabling the thin-film-transistors of the pixels P1R˜P2B to be all shielded by the corresponding V-shaped bumps thereof. The remaining pixels P3R˜P4B can be disposed according to the way of disposing of the above pixels P1R˜P2B, the way of disposing the third pixel P3 and the fourth pixel P4 of the first embodiment, or a combination of the method disclosed in above embodiments and other methods. Anyone who is skilled in the technology of the invention will obtain the way of disposing the pixels P3R˜P4B and the way of disposing is not repeated here.

In short, the way of connecting the thin-film-transistor to the scan line and the data line can be achieved by grouping four pixels as a unit. That is, the first embodiment to the fourth embodiment of the invention plus three primary colors of red, green and blue, such that a number of combinations are obtained. It is noteworthy that the direction of the opening of the pattern positioned above the first substrate has to match with the disposition of the thin-film-transistor, such that all of the thin-film-transistor are shielded by the pattern, part of the thin-film-transistor is shielded by the pattern, or that all of the thin-film-transistor are not shielded by the pattern. Besides, the method of driving the pixels may change according to the change in the connection of the thin-film-transistor, but is still within the driving method disclosed in the first embodiment to the fourth embodiment of the invention.

The liquid crystal display panel disclosed in the above embodiments of the invention comprises a bump having a mirror reflection for enabling the transmittance when viewed from the left to be the same with the transmittance when viewed from the right, such that the rate of brightness change corresponding to the change in grey level when viewed from the right is symmetric with the rate of brightness change corresponding to the change in grey level when viewed from the left. The liquid crystal display panel of the invention enables the thin-film-transistor of the mirror reflection to match with the position of the opening of the bump to resolve the asymmetry problem of transmittances between different pixels, such that neighboring pixels have the same aperture rate, and that the image display quality of the liquid crystal display panel is improved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display panel, comprising:
a first substrate, comprising:
a first base; and
a first pattern and a second pattern disposed on the first base;
a second substrate, comprising:
a second base;
a first data line disposed on the second base, wherein the first pattern and the second pattern are symmetric with respect to the first data line;
a first scan line and a second scan line, both disposed on the second base and perpendicular to the first data line;
a first pixel comprising a first thin-film-transistor coupled to the first scan line and the first data line; and
a second pixel comprising a second thin-film-transistor coupled to the second scan line and the first data line; and
a liquid crystal layer interposed between the first substrate and the second substrate.

2. The liquid crystal display panel according to claim 1, wherein the first pattern comprises a V-shaped bump.

3. The liquid crystal display panel according to claim 2, wherein the V-shaped bump has an opening substantially facing the first data line.

4. The liquid crystal display panel according to claim 1, wherein at least part of the first pattern overlaps the first thin-film-transistor, and at least part of the second pattern overlaps the second thin-film-transistor.

5. The liquid crystal display panel according to claim 1, wherein the first substrate further comprises a third pattern and a fourth pattern, both disposed on the first base and symmetric with respect to the first data line; and the second substrate further comprises:
a second data line and a third data line, both disposed on the second base and at two sides of the first data line, respectively;
a third scan line-disposed on the second base, wherein the second scan line is disposed between the first scan line and the third scan line;
a third pixel comprising a third thin-film-transistor coupled to the second scan line and the second data line; and
a fourth pixel comprising a fourth thin-film-transistor coupled to the third scan line and the third data line.

6. The liquid crystal display panel according to claim 5, wherein the direction of an opening of the first pattern is opposite to the direction of an opening of the third pattern.

7. The liquid crystal display panel according to claim 5, wherein at least part of the third pattern overlaps the third thin-film-transistor, and at least part of the fourth pattern overlaps the fourth thin-film-transistor.

8. A method for driving the liquid crystal display panel according to claim 1, comprising:
during a first timing period, sequentially turning on the first thin-film-transistor and the second thin-film-transistor via the first scan line and the second scan line, respectively; and
applying a pixel voltage to the first pixel and the second pixel via the first data line.

9. A method for driving the liquid crystal display panel according to claim 5, comprising:
during a first timing period, sequentially turning on the first thin-film-transistor via the first scan line, turning on the second thin-film-transistor and the third thin-film-transistor via the second scan line, and turning on the fourth thin-film-transistor via the third scan line;
applying a first pixel voltage to the first pixel and the second pixel via the first data line;
applying a second pixel voltage to the third pixel via the second data line; and
applying a third pixel voltage to the fourth pixel via the third data line.
